(19) United States
(12) Patent Application Publication
(10) Pub. No.: US 2026/0109425 A1
(43) Pub. Date: Apr. 23, 2026

(54) SADDLE TUBE LOCKING DEVICE

(71) Applicant: Jiangsu Aima Manufacturing & Technology Co., Ltd., Wuxi City (CN)

(72) Inventor: Wei Tian, Wuxi City (CN)

(21) Appl. No.: 19/021,358

(22) Filed: Jan. 15, 2025

(30) Foreign Application Priority Data
Oct. 18, 2024 (CN) 202422531149.4

(51) Int. Cl. B62K 19/36

(52) U.S. Cl. CPC B62K 19/36

(57) ABSTRACT

The present disclosure relates to the technical field of electric vehicle accessories, and specifically to a saddle tube locking device. The saddle tube locking device is configured for locking the saddle tube of an electric bicycle, including a fixing mechanism, a jacking mechanism, and a locking mechanism. The fixing mechanism is sleeved on an outer side of a middle tube of the electric bicycle, and the fixing mechanism is provided with a holding space. The holding space is in communication with the middle tube, and the jacking mechanism is arranged inside the holding space. The locking mechanism is arranged on one side of the holding space away from the middle tube and is configured to adjust the distance between the jacking mechanism and the middle tube.

### CROSS-REFERENCES TO RELATED APPLICATIONS

The disclosure claims priority to Chinese Patent Application No. 2024225311494, entitled “SADDLE TUBE LOCKING DEVICE” filed on Oct. 18, 2024 with the Chinese Patent Office, the entire contents of which are incorporated herein by reference.

### TECHNICAL FIELD

The present disclosure relates to the technical field of electric vehicle accessories, and specifically to a saddle tube locking device.

### BACKGROUND ART

As a low-carbon and environmentally friendly personal transportation tool, electric bicycles are becoming increasingly popular and widely used.

Currently, existing electric vehicle saddle tube locking mechanisms are mostly annular clamp locking components, which have higher requirements for the outer diameter of the frame and the inner diameter of the saddle tube. Therefore, they cannot be used for types of frames where the diameter of the middle tube significantly differs from the diameter of the saddle tube, leading to considerable limitations and low applicability.

### SUMMARY

(1) The present disclosure provides a saddle tube locking device to solve the technical issue of low applicability of the saddle tube locking in the prior art.

### (2) TECHNICAL SOLUTION

To solve the above technical issue, an embodiment of the present disclosure provides a saddle tube locking device configured for locking the saddle tube of an electric bicycle, including a fixing mechanism, a jacking mechanism, and a locking mechanism.

The fixing mechanism is sleeved on an outer side of a middle tube of the electric bicycle, and the fixing mechanism is provided with a holding space. The holding space is in communication with the middle tube, and the jacking mechanism is arranged inside the holding space. The locking mechanism is arranged on one side of the holding space away from the middle tube and is configured to adjust the distance between the jacking mechanism and the middle tube.

Further, the jacking mechanism includes a jacking block, and the jacking block is arranged inside the holding space. The locking mechanism passes through a side wall of the fixing mechanism and abuts the jacking block to adjust the distance between the jacking block and the middle tube.

Further, the fixing mechanism includes a bushing, wherein the bushing is sleeved on the outer side of the middle tube. The jacking block is arranged inside the bushing, and the locking mechanism passes through the side wall of the bushing and abuts the jacking block.

Further, the holding space is arranged in the bushing, and the side wall of the bushing is further provided with a connection hole. The connection hole communicates with the holding space, and the locking mechanism passes through the connection hole and abuts the jacking block.

Further, the bushing is provided with a protruding part. The protruding part is provided with strip-shaped openings along both sides of its axial direction, and the two strip-shaped openings communicate with each other to form the holding space.

Further, the jacking block is capable of moving within the holding space. After passing through the connection hole, the locking mechanism abuts the jacking block to adjust the jacking block closer to or further away from the middle tube.

Further, at least two connection holes are provided, with each connection hole axially arranged at intervals along the extension direction of the bushing.

Further, the connection hole is arranged on a side wall of the protruding part adjacent to the strip-shaped opening.

Further, the locking mechanism includes a locking member, with the number of locking members corresponding to the number of connection holes. The locking member passes through the connection hole and abuts the jacking block.

Further, the locking member is an adjustment bolt.

The beneficial effects of the present disclosure are as follows.

The saddle tube locking device provided by the present disclosure, configured for locking the saddle tube of an electric bicycle, includes a fixing mechanism, a jacking mechanism, and a locking mechanism. The fixing mechanism is sleeved on the outer side of the middle tube of the electric bicycle; the fixing mechanism is provided with a holding space; and the holding space communicates with the middle tube. The jacking mechanism is arranged inside the holding space, and the distance between the jacking mechanism and the middle tube is adjusted by the locking mechanism, thereby achieving the locking of the saddle tube. Therefore, the saddle tube locking device provided by the present disclosure can be used for types of frames where the diameter of the middle tube significantly differs from the diameter of the saddle tube, thus offering good applicability without excessive limitations.

### BRIEF DESCRIPTION OF DRAWINGS

In order to more clearly illustrate the specific embodiments of the present disclosure or the technical solution in the prior art, the drawings required to be used in the description of the specific embodiment or prior art will be briefly introduced as follows. Obviously, the drawings described below are some embodiments of the present disclosure, for those of ordinary skill in the art, without paying inventive effort, may also obtain other drawings according to these drawings.

FIG. 1 is a side view of an overall structure of a saddle tube locking device provided by the embodiment of the present disclosure;

FIG. 2 is a front view of an overall structure of a saddle tube locking device provided by the embodiment of the present disclosure; and

FIG. 3 is an oblique side view of an overall structure of a saddle tube locking device provided by the embodiment of the present disclosure.

### REFERENCE NUMERALS

100—fixing mechanism; 101—bushing; 102—connection hole; 103—protruding part; 104—strip-shaped opening;
200—jacking mechanism; 201—jacking block; and
300—locking mechanism.

### DETAILED DESCRIPTION OF EMBODIMENTS

The technical solutions of the present disclosure will be clearly and completely described below in connection with the embodiments. Obviously, the described embodiments are a part of the embodiments of the present disclosure and not all of the embodiments. Based on the embodiments in the present disclosure, all other embodiments obtained by those of ordinary skill in the art without making inventive efforts are within the scope of protection of the present disclosure.

In the description of the present disclosure, it should be noted that the terms “top”, “bottom”, etc., indicate an orientation or positional relationship based on the orientation or positional relationship shown in the drawings and are intended only to facilitate and simplify the description of the present disclosure, not to indicate or imply that the device or element referred to must have a particular orientation, be constructed and operate in a particular orientation, and therefore are not to be construed as limiting the present disclosure. In addition, the terms “first” and “second” are used for descriptive purposes only and are not to be construed as indicating or implying relative importance.

In the description of the present disclosure, it should also be noted that unless otherwise clearly stipulated and limited, the terms “mount”, “connect”, and “link” should be understood in a broad sense. For example, it can be a fixed connection, a detachable connection, or an integral connection; it can be a mechanical connection or an electrical connection; and it can be a direct communication, an indirect communication through an intermediary, or an internal communication between two components. Those of ordinary skill in the art can understand the meanings of the above terms in the present disclosure according to specific situations. In the description of the present disclosure, unless otherwise indicated, the term “multiple” means two or more.

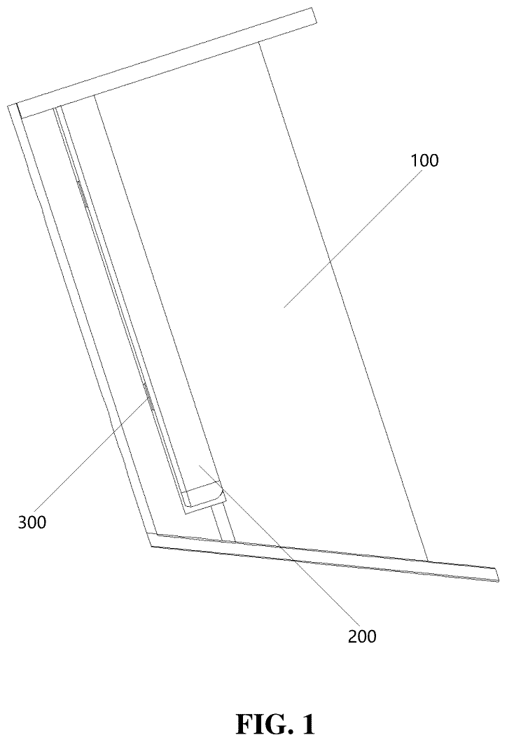

As shown in FIGS. 1 to 3, the present disclosure provides a saddle tube locking device configured for locking the saddle tube of an electric bicycle, including a fixing mechanism 100, a jacking mechanism 200, and a locking mechanism 300. The fixing mechanism 100 is sleeved on an outer side of a middle tube of the electric bicycle, and the fixing mechanism 100 is provided with a holding space. The holding space is in communication with the middle tube, and the jacking mechanism 200 is arranged inside the holding space. The locking mechanism 300 is arranged on one side of the holding space away from the middle tube and is configured to adjust the distance between the jacking mechanism 200 and the middle tube.

In the embodiment, the saddle tube locking device includes the fixing mechanism 100, the jacking mechanism 200, and the locking mechanism 300. The fixing mechanism 100 is sleeved on the outer side of the middle tube of the electric bicycle, and the fixing mechanism 100 is provided with the holding space, and the holding space communicates with the middle tube. The jacking mechanism 200 is arranged inside the holding space, and the distance between the jacking mechanism 200 and the middle tube is adjusted by the locking mechanism 300, thereby achieving the locking of the saddle tube. Therefore, the saddle tube locking device provided by the present disclosure can be used for types of frames where the diameter of the middle tube significantly differs from the diameter of the saddle tube, thus offering good applicability without excessive limitations.

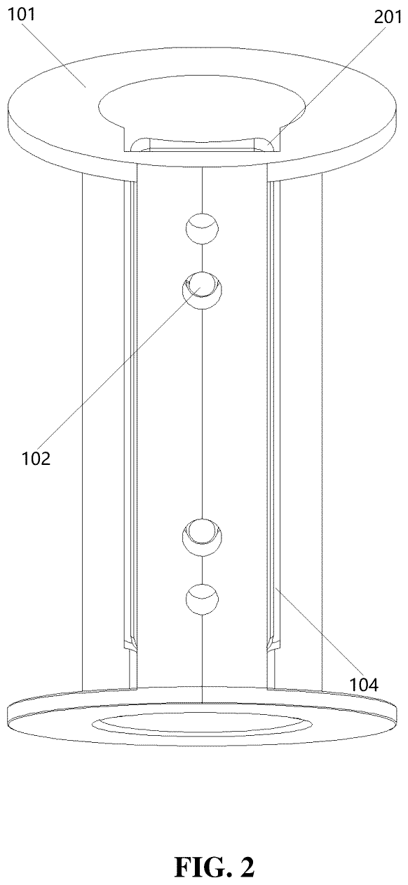

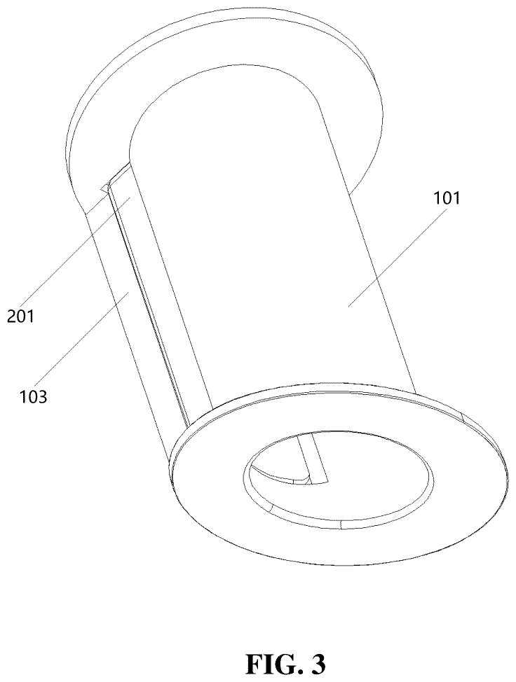

According to one embodiment of the present disclosure, with reference to FIG. 2 and FIG. 3, the jacking mechanism 200 includes a jacking block 201, and the jacking block 201 is arranged inside the holding space. The locking mechanism 300 passes through a side wall of the fixing mechanism 100 and abuts against the jacking block 201 to adjust the distance between the jacking block 201 and the middle tube.

In the embodiment, the jacking mechanism 200 includes the jacking block 201, and the jacking block 201 is directly mounted inside the holding space of the fixing mechanism 100. After the locking mechanism 300 passes through the side wall of the fixing mechanism 100, it directly abuts the side wall of the jacking block 201, thereby adjusting the distance between the jacking block 201 and the middle tube of the frame. By arranging the above-mentioned jacking block 201 and coordinating with the locking mechanism 300, the locking of the saddle tube is achieved, which enables the saddle tube locking device provided by the present disclosure to be used for types of frames where the diameter of the middle tube significantly differs from the diameter of the saddle tube, thus increasing the overall applicability.

According to one embodiment of the present disclosure, with reference to FIG. 1, FIG. 2, and FIG. 3, the fixing mechanism 100 includes a bushing 101, wherein the bushing 101 is sleeved on the outer side of the middle tube. The jacking block 201 is arranged inside the bushing 101, and the locking mechanism 300 passes through the side wall of the bushing 101 and abuts the jacking block 201.

In the embodiment, the fixing mechanism 100 includes the bushing 101, and the bushing 101 is sleeved on the outer side of the middle tube. Preferably, the jacking block 201 is arranged inside the bushing 101, and the locking mechanism 300 passes through the side wall of the bushing 101 and abuts the jacking block 201 to adjust the distance between the jacking block 201 and the middle tube.

According to one embodiment of the present disclosure, with reference to FIG. 1, FIG. 2, and FIG. 3, the holding space is arranged in the bushing 101, and the side wall of the bushing 101 is further provided with a connection hole 102. The connection hole 102 communicates with the holding space, and the locking mechanism 300 passes through the connection hole 102 and abuts the jacking block 201.

In the embodiment, the holding space is arranged in the bushing 101 to facilitate the arrangement of the jacking block 201 inside the bushing 101. Preferably, a connection hole 102 is arranged in the side wall of the bushing 101, and the connection hole 102 is directly in communication with the holding space. During mounting, the end of the locking mechanism 300 is directly passed through the connection hole 102 to abut the jacking block 201. By adjusting the length of the end of the locking mechanism 300 after passing through the connection hole 102, the distance between the jacking block 201 and the middle tube can be changed. The entire adjustment process is simple, and the principle is clear.

According to one embodiment of the present disclosure, with reference to FIG. 1, FIG. 2, and FIG. 3, the bushing 101 is provided with a protruding part 103. The protruding part 103 is provided with strip-shaped openings 104 along both sides of its axial direction, and two strip-shaped openings 104 communicate with each other to form the holding space.

In the embodiment, the protruding part is provided on the side surface of the bushing 101, and the strip-shaped openings 104 are arranged on both sides of the protruding part along its axial direction. The entire protruding part is hollow and directly communicates with the middle tube. The two strip-shaped openings 104 are also communicated, thus forming the holding space that communicates directly with the middle tube and is configured for placing the jacking block 201.

According to one embodiment of the present disclosure, with reference to FIG. 2 and FIG. 3, the jacking block 201 is movable within the holding space. After the locking mechanism 300 passes through the connection hole 102, it abuts the jacking block 201 to adjust the jacking block 201 closer to or further away from the middle tube.

In the embodiment, the jacking block 201 is movable within the holding space. By using the locking mechanism 300 to pass through the connection hole 102 and abut the jacking block 201, the length of the end of the locking mechanism 300 passing through the connection hole 102 can be adjusted to move the jacking block 201 within the holding space, making it closer to or farther from the middle tube.

According to one embodiment of the present disclosure, with reference to FIG. 2, at least two connection holes 102 are provided, with each connection hole 102 axially arranged at intervals along the extension direction of the bushing 101.

In the embodiment, at least two connection holes 102 are provided, and the connection holes 102 are axially arranged at intervals along the extension direction of the bushing 101. Optionally, the number of connection holes 102 can be set to three, four, or more, which can be increased or decreased according to actual use requirements to meet the usage needs.

According to one embodiment of the present disclosure, with reference to FIG. 2, the connection hole 102 is arranged on a side wall of the protruding part 103 adjacent to the strip-shaped opening 104.

In the embodiment, optionally, the connection hole 102 is arranged directly in the side wall of the protruding part 103, i.e., the side wall of the protruding part 103 adjacent to the strip-shaped opening 104, so that the locking mechanism 300 can pass through the connection hole 102 and directly abut the side wall of the jacking block 201. This adjusts the distance between the jacking block 201 and the middle tube, thereby achieving the locking of the saddle tube and allowing the saddle tube locking device provided by the present disclosure to be used for types of frames where the diameter of the middle tube significantly differs from the diameter of the saddle tube.

According to one embodiment of the present disclosure, with reference to FIG. 1, the locking mechanism 300 includes a locking member, with the number of locking members and the number of connection holes 102 being in one-to-one correspondence. The locking member passes through the connection hole 102 and abuts the jacking block 201.

In the embodiment, the locking mechanism 300 includes a locking member. Preferably, the number of locking members corresponds one-to-one with the number of connection holes 102, meaning that the quantities of the two are equal. Each connection hole 102 is provided with a corresponding locking member. During adjustment, the locking member passes through the corresponding connection hole 102 and abuts the jacking block 201. Then, by adjusting the length of protruding from the end of the locking member after passing through the connection hole 102, the jacking block 201 is driven to move closer to or farther from the middle tube. Therefore, the locking of the saddle tube is achieved, which enables the saddle tube locking device provided by the present disclosure to be used for types of frames where the diameter of the middle tube significantly differs from the diameter of the saddle tube.

According to one embodiment of the present disclosure, with reference to FIG. 1, the locking member is an adjustment bolt.

In the present embodiment, preferably, the locking member is an adjustment bolt, and the connection hole 102 is provided as a threaded hole that is compatible with the adjustment bolt, i.e., a thread is provided on the inner side wall of the connection hole 102. The threaded connection controls the length of the adjustment bolt protruding from the end of the connection hole 102, which in turn drives the jacking block 201 to move closer to or further away from the middle tube. Therefore, the locking of the saddle tube is achieved, which enables the saddle tube locking device provided by the present disclosure to be used for types of frames where the diameter of the middle tube significantly differs from the diameter of the saddle tube.

Optionally, the locking member can also be a screw, bolt, or any other component capable of changing the length of its end protruding from the connection hole 102. These components fall within the design idea of the present disclosure and should be included within the scope of protection of the present disclosure.

The above is merely a preferred embodiment of the present disclosure and is not intended to limit the present disclosure. Any modifications, equivalent substitutions, or improvements made within the spirit and principles of the present disclosure should be included within the scope of protection of the present disclosure.

1. A saddle tube locking device, configured for locking a saddle tube of an electric bicycle, comprising a fixing mechanism, a jacking mechanism, and a locking mechanism, wherein
the fixing mechanism is sleeved on an outer side of a middle tube of the electric bicycle;
the fixing mechanism is provided with a holding space; the holding space is in communication with the middle tube; the jacking mechanism is arranged inside the holding space; and the locking mechanism is arranged on one side of the holding space away from the middle tube and is configured to adjust a distance between the jacking mechanism and the middle tube.

2. The saddle tube locking device according to claim 1, wherein the jacking mechanism comprises a jacking block; the jacking block is arranged inside the holding space; and the locking mechanism passes through a side wall of the fixing mechanism and abuts the jacking block to adjust a distance between the jacking block and the middle tube.

3. The saddle tube locking device according to claim 2, wherein the fixing mechanism comprises a bushing; the bushing is sleeved on an outer side of the middle tube; the jacking block is arranged inside the bushing; and the locking mechanism passes through a side wall of the bushing and abuts the jacking block.

4. The saddle tube locking device according to claim 3, wherein the holding space is arranged in the bushing; the side wall of the bushing is further provided with a connection hole; the connection hole communicates with the holding space; and the locking mechanism passes through the connection hole and abuts the jacking block.

5. The saddle tube locking device according to claim 4, wherein the bushing is provided with a protruding part; the protruding part is provided with strip-shaped openings along both sides of its axial direction; and the two strip-shaped openings communicate with each other to form the holding space.

6. The saddle tube locking device according to claim 5, wherein the jacking block is capable of moving within the holding space, and after passing through the connection hole, the locking mechanism abuts the jacking block to adjust the jacking block closer to or further away from the middle tube.

7. The saddle tube locking device according to claim 5, wherein at least two connection holes are provided, with each of the connection holes axially arranged at intervals along an extension direction of the bushing.

8. The saddle tube locking device according to claim 7, wherein the connection hole is arranged on a side wall of the protruding part adjacent to the strip-shaped opening.

9. The saddle tube locking device according to claim 8, wherein the locking mechanism comprises a locking member, with a number of locking members corresponding to a number of connection holes, and the locking member passes through the connection hole and abuts the jacking block.

10. The saddle tube locking device according to claim 9, wherein the locking member is an adjustment bolt.
